(19) United States
(12) Patent Application Publication
(10) Pub. No.: US 2005/0230409 A1
(43) Pub. Date: Oct. 20, 2005

(54) Dispenser for distributing individual portions of tablets

(76) Inventor: Alfred von Schuckmann, Kevelaer (DE)

Correspondence Address: Martin A Farber, Suite 473, 866 United Nations Plaza, New York, NY, 10017, US

(21) Appl. No.: 10/513,621

(22) PCT Filed: May 14, 2003
(86) PCT No.: PCT/EP03/05026

§ 371 Date: May 23, 2005

(30) Foreign Application Priority Data
May 16, 2002 (DE) 10221729.7

(51) Int. Cl. B65H 1/00; G07F 11/46; A24F 15/04; B65G 59/00

(52) U.S. Cl. 221/68; 221/190

(57) ABSTRACT

Dispenser for individually apportioned delivery of tablets (3) has a cylindrical housing (1), and a slide (2) which is displaceable for limited travel. The dispenser includes a tablet-storage space (V) with a connecting delivery passage (7) corresponding to the tablet thickness, for which passage end-side closing-off surfaces and profiled flanks are formed, in part, on the housing and integrally formed, in part, on the slide (2). The delivery passage (7) is defined by a spacing (y) between an inner wall surface (20′) of a cylinder-housing wall (20) and a cylindrically concentrically curved wall (25) of the slide (2).

The invention relates to a dispenser for individually apportioned delivery of tablets, having a cylindrical housing, a slide, which is displaceable for limited travel, and a tablet-storage space with a connecting delivery passage corresponding to the tablet thickness, for which passage end-side closing-off surfaces and profiled flanks are formed, in part, on the housing and integrally formed, in part, on the slide.

Austrian Patent Specification 347595 discloses a dispenser for individually apportioned delivery of tablets in which a rotary slide mounted in the cylindrical housing forms, at the periphery, a multiplicity of delivery passages which, at the same time, form a separating chamber. The tablets, which rest on a cone, progressively slide into the delivery passages from a common tablet-storage space. The outer wall of the delivery passage is formed by the cup-like housing. Under rotation, and with latching provided by means of a catch, a delivery passage passes, step by step, in front of a lateral outlet opening of the cylindrical housing. Here, the tablet passes outward via a downwardly sloping ramp.

European Patent Specification 0345413 discloses a dispenser of the generic type with a separating chamber. The individually apportioned delivery of the tablets here, rather than taking place visibly from the side, takes place from an underside covering of the base dispenser.

It is an object of the invention to form a dispenser of the generic type in a functionally advantageous manner, with effective pre-ordering of the tablets.

This object is achieved first and foremost in the case of a dispenser having the features of claim 1, this being based on the fact that the delivery passage is defined by a spacing between the inner surface of the cylinder-housing wall and the cylindrically concentrically curved wall of the slide. Such a configuration achieves a dispenser of the generic type with increased use value. This results from surprisingly effective pre-ordering of the tablets, even layerwise. The tablets located nearest to the delivery passage exhibit clearly the tendency to engage closely against the cylindrical inner surface of the cylinder housing wall. This is because the tablets, influenced by the pressure of the rest of the store of tablets, position themselves, namely with their broad surfaces against the said inner surface. As a result of this adjustment, moreover also taking place in the projection of the extent of the delivery passage, incorrect indexation in the dispenser mechanism hardly arises.

The subject matters of the rest of the claims are explained hereinbelow in relation to the subject matter of claim 1, but may also be important in their own right. It is thus further provided that the slide is configured cylindrically concentrically over its entire length, and the delivery passage is formed to follow a cylindrically curved transverse window. On the one hand, this results in good guidance and, on the other hand, the operation of charging the delivery passage is controlled to very good effect. It proves to be advantageous here, moreover, if, in the region of the transverse window, a ramp is provided as a feed means to the delivery passage. Such a downwardly sloping ramp affords a large infeed zone into the delivery passage.

It is possible here, for all practical purposes, for the entire cylinder cross-section to be usable as loading by the tablet product. A configuration of even independent importance is achieved by a two-dimensionally curvingly extending restoring spring which is integrally formed on the lower periphery of the slide. The number of parts is reduced as a result of the restoring spring being integrally formed on the slide. Accommodating the restoring spring in the curved peripheral region of the slide makes it possible to keep the useful space, that is to say storage space, at a relatively large volume. In structural terms, it is then advantageous if the chamber for the restoring spring is bounded in the radially inward direction by an outer wall of a drawn-in portion of the cylindrical housing. An advantageous developmental measure is provided by the base of the drawn-in portion forming the ramp by way of its top. Furthermore, it is advantageous if the outer wall of the drawn-in portion grips behind the wall of the slide in the region of the delivery passage. This can be utilized as a guidance support and, in a development, even to the extent where the outer wall forms a counter-latching depression in relation to a latching nose of the slide. The dispenser, which comprises just two components, is thus held together in a functionally appropriate manner. Since, moreover, the slide is removable from the housing, the dispenser is easily opened and refilled by disengagement of the latching nose. The latching is limited to the plugging movement of the two parts one inside the other. Finally, it is also proposed that the restoring spring is supported on the bottom of the restoring-spring chamber by means of a protuberance. The protuberance has a partially stiffening effect there. This has the result that those parts of the said restoring spring which are remote from the protuberance can be incorporated to a more pronounced extent into the corresponding movement.

The subject matter of the invention is explained in more detail hereinbelow with reference to an exemplary embodiment illustrated in the drawings, in which:

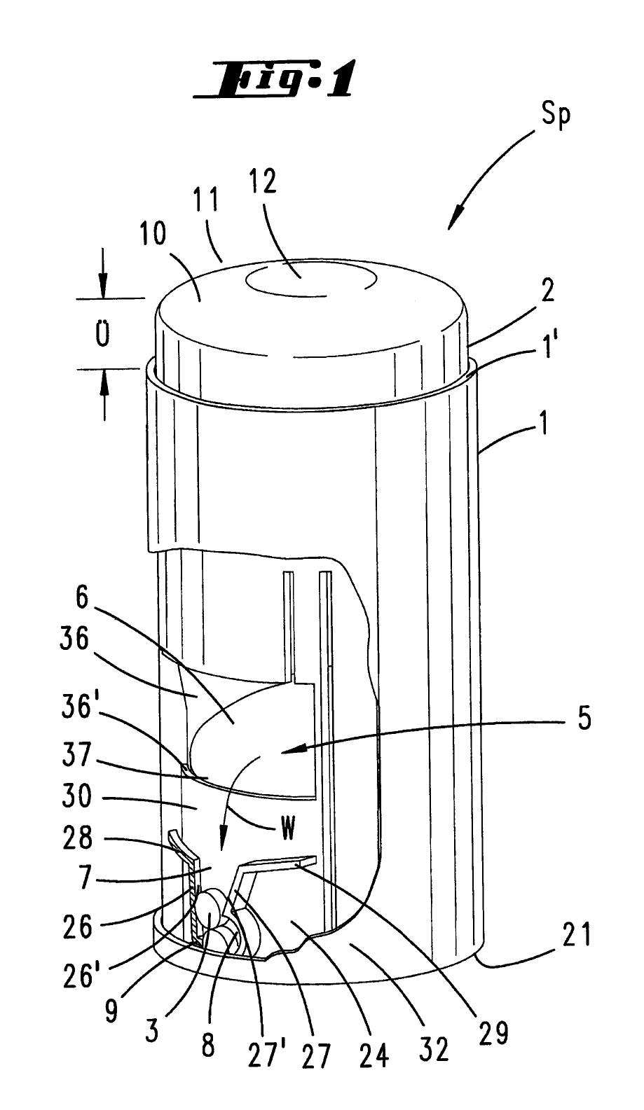

FIG. 1 shows the dispenser in perspective view, partly cut away, in a basic position,

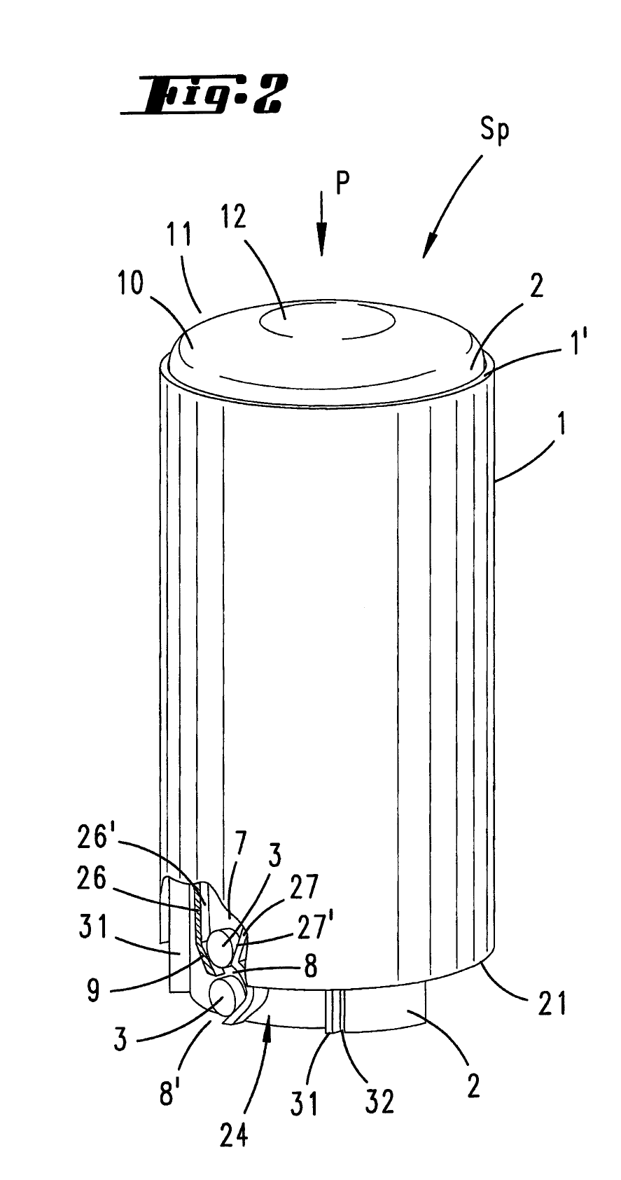

FIG. 2 shows the dispenser likewise in diagrammatic representation, to be precise in the actuating position, but only cut away in the region of the delivery passage,

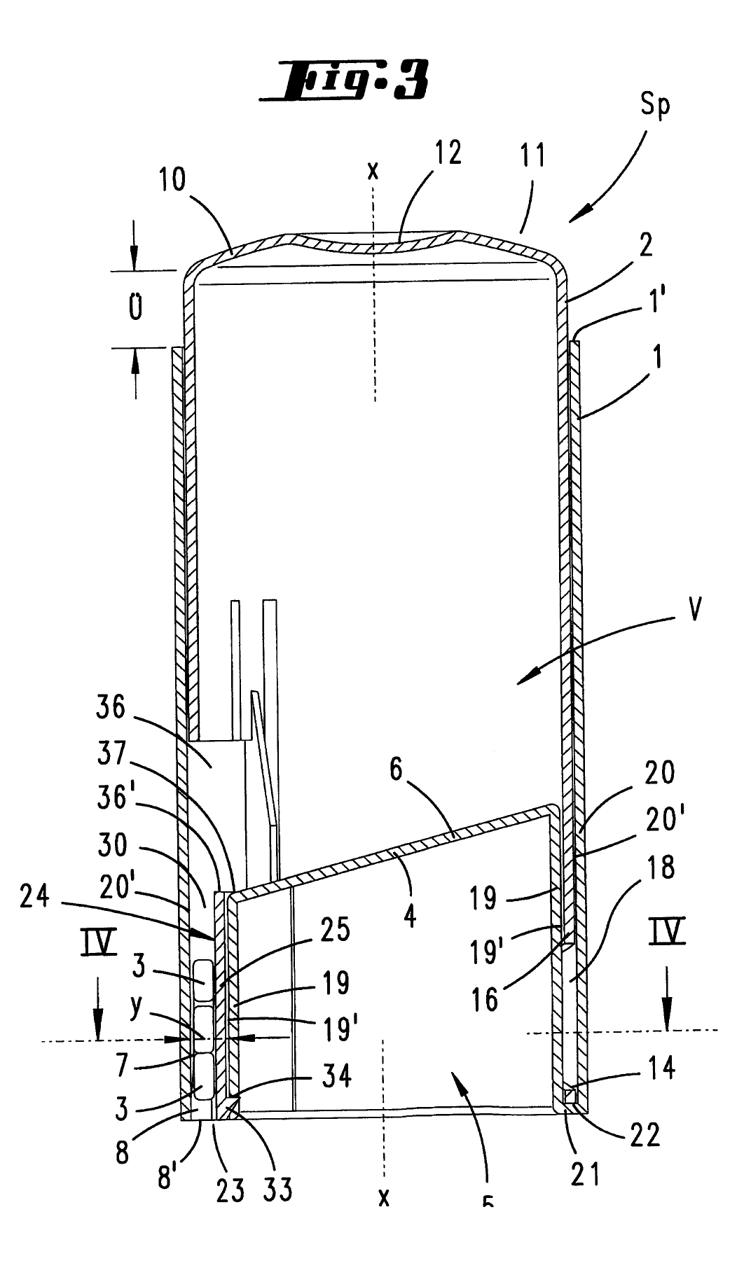

FIG. 3 shows a vertical section through the dispenser in the basic position,

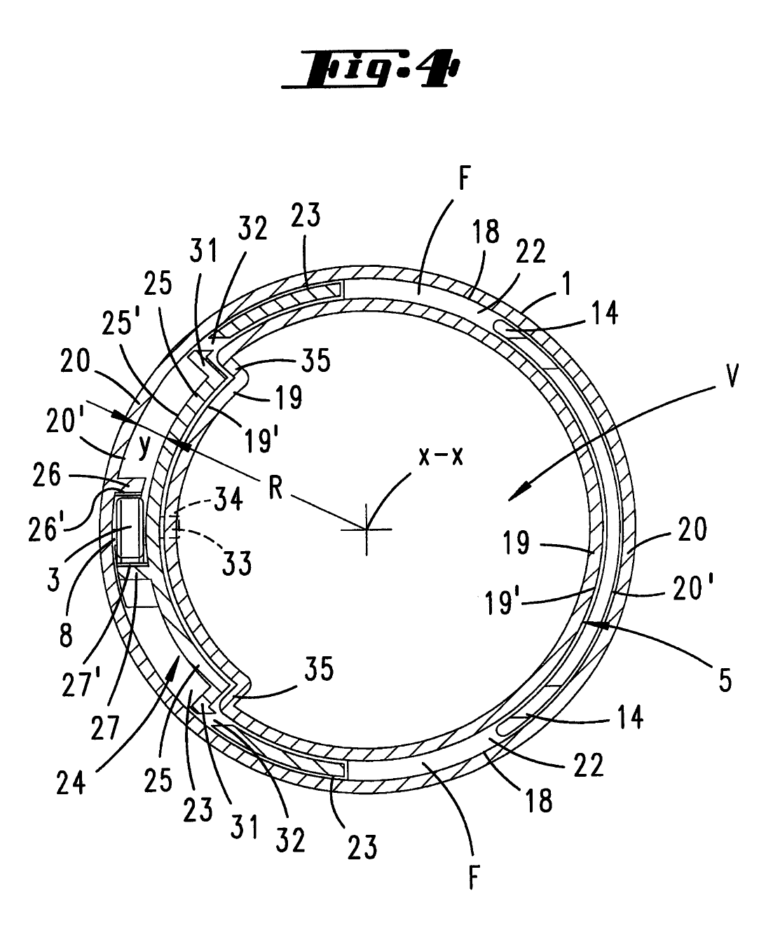

FIG. 4 shows the section along line IV-IV in FIG. 3, and

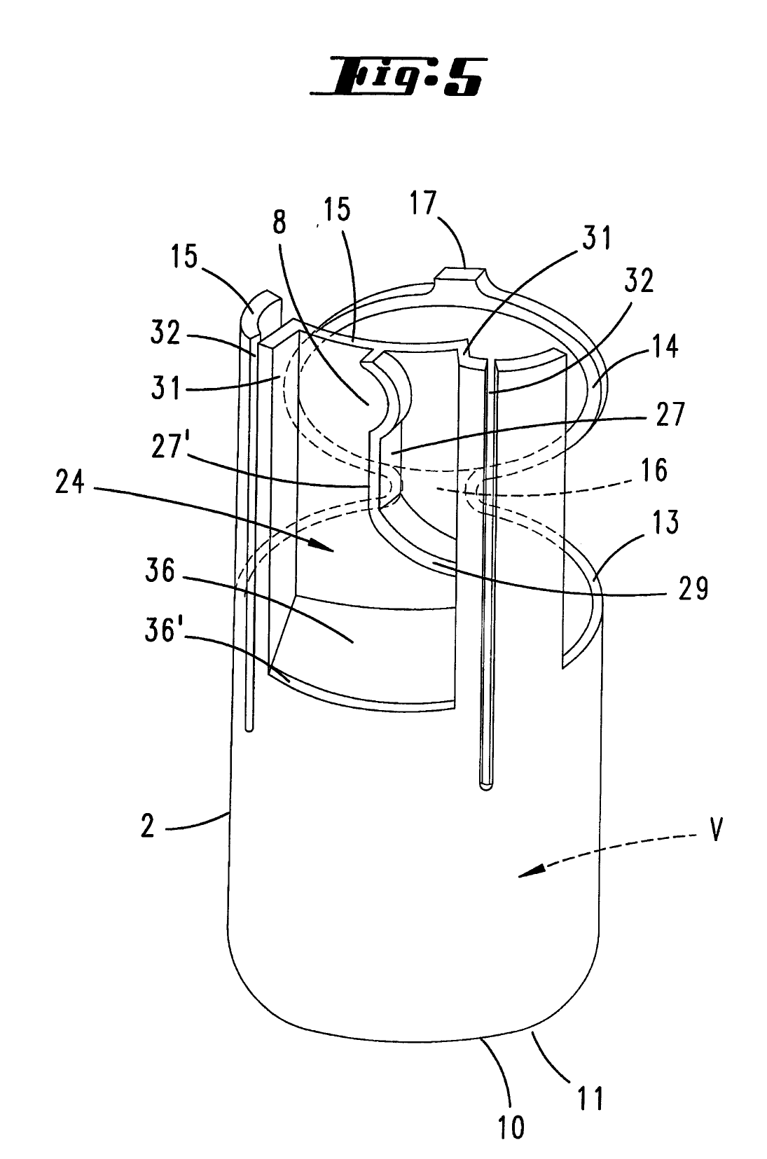

FIG. 5 shows the slide in perspective individual illustration, oriented in a manner which is appropriate for filling purposes.

The dispenser Sp illustrated comprises just two parts, to be precise a housing 1 and a slide 2, each provided, in part, with the necessary functional elements of the so-called dispenser mechanism.

The dispenser is a manually actuable stand-up unit for individually apportioned delivery of tablets 3.

The tablets 3 are accommodated in a tablet-storage space V in a manner which allows refilling.

The lower termination of the tablet-storage space V is formed by a base 4. The latter slopes downwardly, i.e. is inclined in relation to the longitudinal center axis x-x of the dispenser Sp, which is of basically rotationally symmetrical configuration. The base 4 is achieved by a drawn-in portion 5 of the underside of the housing 1. The top of this drawn-in portion 5, corresponding to the base 4 described, forms a ramp 6 here.

Corresponding to the circular cross-section of the housing 1, the drawn-in portion 5 is also circular, apart from the region which, at the lowest point of the ramp 6, merges into a vertically directed, axially oriented delivery passage 7. There, as can be seen from FIG. 4, an inwardly directed offset is provided on the drawn-in portion 5.

The separating mechanism is provided in the resulting space. The core of this separating mechanism is a tablet-separating chamber 8. In the latter, in each case just one tablet 3 is accommodated on the delivery path arrow W. The tablets 3 which follow in an ordered manner in the delivery passage 7 are held back by a separating finger 9 during the delivery operation.

At the top, the tablet-storage space V is closed off by a top 10. The latter is integrally formed on the circularly cross-sectionally configured slide 2. In the basic position of the dispenser Sp, it is spaced apart from the end periphery 1′ of the housing 1, this end periphery being open in a tubular manner there, by a defined vertical projection U which corresponds at least to the actuating displacement for delivery of a tablet 3. In this respect, the exposed region of the guided, basically cup-like slide 2 can be utilized as an actuating button 11 of the dispenser Sp. The displacement direction is indicated by arrow P. As seen from the outside, the actuating button 11 is curved slightly convexly with an oppositely directed indent 12 disposed in the vertex. This increases the grip for actuating purposes.

The displacement of the slide 2 in the housing 1 takes place counter to spring force. This is applied by a compression spring which is prestressed to a slight extent. In specific terms, this is realized by a two-dimensionally curvingly extending restoring spring 14 which is integrally formed on a lower periphery 13 of the slide 2, this being the set-back lower periphery 13. The lower periphery in the region of the maximum axial length is designated 15 (see, for example, FIG. 5).

The restoring spring 14 is in the form of an O which follows the cross-sectional circular shape of the dispenser Sp. The correspondingly elliptical configuration can be gathered from FIG. 5. The longer axis of the ellipse extends perpendicularly to the longitudinal center axis x-x of the dispenser Sp. An attachment bridge 16 to the set-back periphery 13 and a protuberance 17 terminating approximately level with the maximum periphery 15 are located in the shorter axis of the ellipse, this axis thus being oriented parallel in space to the longitudinal center axis x-x. This protuberance has a partially stiffening action, so that the spring movement passes more to the narrower regions of curvature of the restoring spring 14. The same also applies, in principle, in respect of the even somewhat wider-formed attachment bridge 16. An extent of the spring or a protuberance position which goes beyond the periphery 15 can be utilized as spring prestressing.

The restoring spring 14 extends a good third of the way around in the circumferential direction. Allowance is made to best possible effect for the spring-deflection clearance F here by virtue of the adjacent region of the wall of the slide 2 being cut away. The cut-out leads to the set-back lower periphery 13.

The space for accommodating the restoring spring 14 is adapted to the curved profile of the same. The corresponding restoring-spring chamber 18 is achieved by an annular gap between a wall 19 of the cylindrical drawn-in portion 5 and the corresponding wall 20 of the cylindrical housing 1. The annular-gap width of the restoring-spring chamber 18 is such that the restoring spring 14 and the wall of the slide 2 are slideably accommodated therein. There is sufficient play between an outer-wall surface 19′ of the wall 19 of the drawn-in portion 5, this surface supporting the restoring spring 14 in the radially inward direction, and the corresponding inner-wall surface 20′ of the wall 20 of the housing 1.

The lower termination of the restoring-spring chamber 18 is formed by an annularly extending bent portion 21 which is achieved as a result of the drawn-in portion 5. The resulting bottom of the restoring-spring chamber 18 is designated 22.

The bottom 22 extends along well over half the annular surface of the turn 21, see FIG. 4. It can be gathered there that the bottom 22 is adjoined by an annular opening 23. This allows, in continuation, for the offset profile of the slide head 24, which includes the delivery passage 7.

The delivery passage 7 here is defined by a spacing y between the correspondingly radially inwardly offset wall 25 of the slide 2, which is cylindrically concentrically curved, and the corresponding inner-wall surface 20′ of the cylinder-housing wall 20 of the dispenser Sp.

The slide 2 has a cylindrically concentric configuration over its entire length.

The spacing y relates radially to the longitudinal center axis x-x. It allows for the extent of a thickness of a tablet 3, including a small amount of tilting play for the same. The radius is designated R.

The delivery passage 7, which is achieved, in part, by oppositely exposed integrally formed portions, tapers in a funnel-like manner over the tablet-separating chamber 8, which is likewise configured by the said integrally formed portions. This separating chamber is bounded in the radial direction by a portion of the said inner-wall surface 20′ of the housing 1 and in a circularly-parallel manner by a portion of the outer-wall surface 25′ of the wall 25 of the slide 2, more specifically of the slide head 24.

In the circumferential direction, flanks 26′ of a strip 26 of the housing 1, these flanks running approximately transversely to the housing, provide the closing-off in this respect of the tablet-separating chamber 8 or of the delivery passage 7. In opposition, a strip 27, which is realized on the slide 2, correspondingly forms flanks 27′ there.

As can clearly be gathered from FIG. 1, the strips 26 and 27 continue in slightly upwardly sloping crosspieces 28 and 29, respectively, which project away from one another. These follow the course taken by the offset recess of the slide head 24, this being achieved by the spacing y. Their width corresponds to the tablet thickness. This results, overall, in a preliminary passage 30 which is in the form of part of a circle and lies above the delivery passage 7. Accordingly, provision is also made here for control of the conditions in which the tablets 3 are fed.

The radial walls leading to the abovedescribed spacing-forming offset of the slide 2 or slide head 24 are designated 31. Slots 32 extend in the outward direction from the radial walls 31, which bound a quarter-circle. These slots extend from the lower free end of the slide 2, more precisely the lower periphery 15 of the same, and run approximately over half the axial length of the cross-sectionally circular slide 2.

The slide head 24 is thus held to be resiliently deflectable, within limits, in the radial direction, which is beneficial for positioning it with latching action, as is the case practised here, see FIG. 3. There, a latching nose 33 is integrally formed at the lower end of the wall 25 of the slide 2. A counter-latching depression 34 extends from the outer-wall surface 19′ of the drawn-in portion 5 of the cylindrical housing 1.

It can then be gathered from FIG. 4 that the outer-wall surface 19′ of the drawn-in portion 5 grips, for all practical purposes with supporting action, behind the wall 25 of the slide 2 or slide head 24 in the region of the delivery passage 7, and also in the vicinity thereof. The wall 19, moreover, takes a course which is adapted to the illustrated offset of the slide head 24. The longitudinally oriented offset step in this respect is designated by the symbol 35. This configuration, at the same time, achieves a detent zone which is located in the circumferential direction on both sides and relieves the latching means 33/34 of loading to best possible effect.

The store of tablets 3 is connected to the delivery path arrow W via a transverse window 36. This results in the items which are to be distributed being connected, in a manner which is appropriate for loose filling, to the abovementioned preliminary passage 30, and then the delivery passage 7, the items being there guided individually into the tablet-separating chamber 8. The corresponding mechanism will not be explained any further here since it is described in detail in European Patent Specification 0345413, which is mentioned in the introduction. In the basic position of the dispenser Sp, the foot 37 of the ramp 6, which functions as a chute, this foot being mentioned above as the lowest point, terminates substantially level with the lower periphery 36′ of the transverse window 36. With actuation in the direction of the arrow P, the slide 2 is displaced such that the abovedescribed window ledge in the form of the lower periphery 36′ passes beneath the level of the foot 37 by the extent of the actuating displacement. The tablet-separating chamber 8 thereby moves beneath the plane of the opening 23. It can be gathered from FIG. 2 how the separating finger 9 holds the penultimate tablet 3 in the delivery passage 7, more precisely in the separating chamber 8, against dropping out.

In order to limit the release displacement, the distance of which is covered by the projection Ü, axially oriented stop means may be provided, for example utilizing the drawn-in portion 5 as a counter-stop.

Forming the dispenser Sp then, in respect of its basic technical design, such that the delivery mechanism and the restoring spring 14, including the plug-in installation means, are adapted to the cylindrical system provided has the effect of ordering the items which are to be delivered, in this case disk-shaped tablets 3, to a surprisingly high degree. Ordering of the tablets in a, for all practical purposes, shingle-like manner, which reduces the polydirectionality of the tablets, already takes place in the region of the tablet-storage space V. The tablet group moving via the transverse window 36 engages, with support on the broad surfaces, against the inner-wall surface 20′ of the wall 20 located in a plate-like manner in front. This, in turn, benefits the ordered entry into the preliminary passage 30, in which the same direction is achieved in every case. The delivery passage 7 is supplied from here, the tablets 3 being forced into a vertically ordered row. As has been found, empty indexations are thus, for the most part, avoided. Added to this is the advantage that, despite the lateral wall of the housing 1 being closed, it is possible to observe the dropping action, since it is possible to see the separating chamber 8 with its discharge openings 8′ via the lower periphery of the dispenser Sp, as a result of the corresponding displacement of the slide.

The dispenser Sp, moreover, is refillable. All that is required for this purpose is for the latching nose 33, which is accessible for gripping purposes on the base of the dispenser Sp, to be disengaged. The slide 2 can be drawn out of the housing 1. Since it is closed via the top 10, it can be filled in the manner of or beaker. The housing 1 is then plugged on in the proper manner with the drawn-in portion 5 directed downward. Once it has been turned over, the dispenser Sp is then ready for further use.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1-9. (canceled)

10. Dispenser (Sp) for individually apportioned delivery of tablets (3), the dispenser comprising a cylindrical housing (1), a slide (2) that is displaceable for limited travel, and a tablet-storage space (V) with a connecting delivery passage (7) corresponding to the tablet thickness; wherein, for the passage, end-side closing-off surfaces and profiled flanks are formed, in part, on the housing and integrally formed, in part, on the slide (2); and wherein the delivery passage (7) is defined by a spacing (y) between an inner wall surface (20′) of a cylinder-housing wall (20) and a cylindrically concentrically curved wall (25) of the slide (2).

11. Dispenser according to claim 10, wherein the slide (2) is configured cylindrically concentrically over its entire length, and the delivery passage (7) is formed to follow a cylindrically curved transverse window (36).

12. Dispenser according to claim 11, wherein in a region of the transverse window (36), a ramp (6) is provided as a feed means to the delivery passage (7).

13. Dispenser according to claim 10, further comprising a curved two-dimensionally extending restoring spring (14) which is integrally formed on the stepped-back lower periphery (13) of the slide (2).

14. Dispenser according to claim 13, further comprising a chamber (18) for the restoring spring (14), wherein the chamber (18) is bounded in a radially inward direction by an outer-wall surface (19′) of a drawn-in portion (5) of the cylindrical housing (1).

15. Dispenser according to claim 14, wherein in a region of the transverse window (36), a ramp (6) is provided as a feed means to the delivery passage (7); and wherein a base (4) of the drawn-in portion (5) forms the ramp (6) by way of its top.

16. Dispenser according to claim 14, wherein the outer-wall surface (19′) of the drawn-in portion (5) grips behind the wall (25) of the slide (2) in the region of the delivery passage (7).

17. Dispenser according to claim 14, the outer-wall surface (19′) forms a counter-latching depression (34) in relation to a latching nose (33) of the slide (2).

18. Dispenser according to claim 14, wherein the restoring spring (14) is supported on a bottom (22) of the restoring-spring chamber (18) by means of a protuberance (17).
